(19) United States
(12) Patent Application Publication
(10) Pub. No.: US 2020/0370678 A1
(43) Pub. Date: Nov. 26, 2020

(54) CHECK VALVE STOP WITH POWDER DAMPER AND METHOD OF MAKING

(71) Applicant: Hamilton Sundstrand Corporation, Charlotte, NC (US)

(72) Inventors: Feng Feng, South Windsor, CT (US); Cheryl Chunyu Dou, Farmington, CT (US); James Streeter, Torrington, CT (US)

(21) Appl. No.: 16/420,615

(22) Filed: May 23, 2019

(51) Int. Cl. F16K 47/02

(52) U.S. Cl. CPC F16K 47/023

(57) ABSTRACT

A check valve has a valve seat defining an aperture and a seating surface. A stop is fixed in position relative to the valve seat and has a solid portion formed as a single homogeneous component. At least one cavity is sealed within the solid portion and is at least partially filed with a particulate material. The solid portion defines a contact surface. A flapper is moveable between a closed position in which the flapper is sealingly engaged with the sealing surface and an open position in which a contact surface of the flapper is in contact with the stop. A method is also disclosed.

### BACKGROUND

This application relates to a check valve stop and a method of making such a stop.

Check valves are known. Typically, a check valve blocks flow of a fluid through a conduit, until the pressure upstream of the valve overcomes a downstream pressure.

One type of check valve utilizes flapper valves having a central pivot axis and a pair of valve plates which seat on the valve seat in the closed position and contact a stop in the open position. Another type of check valve utilizes a flapper valve having one pivot axis to one side and a valve plate which seats on a valve seat.

When the valve plates opens to allow flow, the movement might be rapid. The valve plate may contact the stop in an opening event with a high force. This can lead to the valve plate or stop being damaged and eventually failing.

### SUMMARY

A check valve has a valve seat defining an aperture and a seating surface. A stop is fixed in position relative to the valve seat and has a solid portion formed as a single homogeneous component. At least one cavity is sealed within the solid portion and is at least partially filed with a particulate material. The solid portion defines a contact surface. A flapper is moveable between a closed position in which the flapper is sealingly engaged with the sealing surface and an open position in which a contact surface of the flapper is in contact with the stop.

A method is also disclosed.

These and other features may be best understood from the following drawings and specification.

### BRIEF DESCRIPTION OF THE DRAWINGS

FIG. 1A shows a check valve.

FIG. 1B schematically shows movement of a flapper valve such as in a FIG. 1A check valve.

FIG. 2A is a side view of the check valve.

FIG. 2B is a cross-sectional view of the check valve.

FIG. 3 shows internal details.

FIG. 4 shows a method of making.

### DETAILED DESCRIPTION

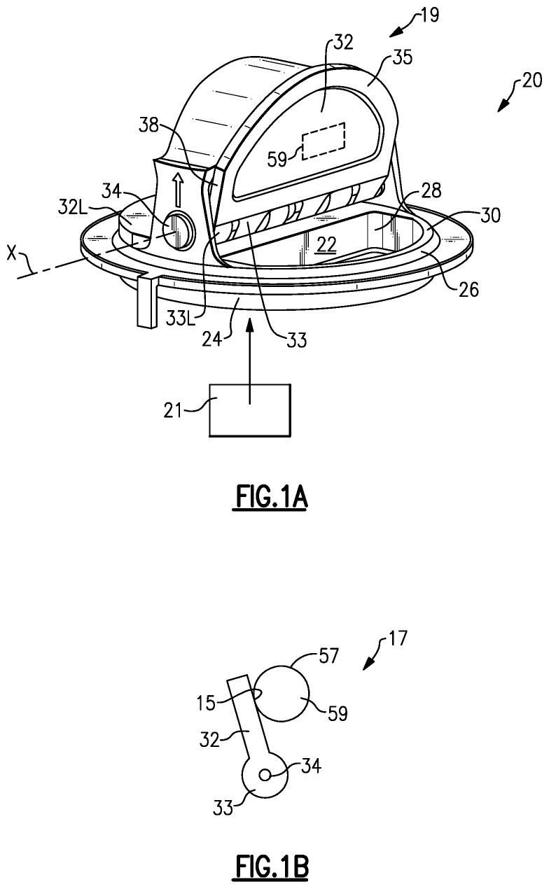

FIG. 1A shows a fluid system 20 including a check valve 19 incorporating a flow passage 22 communicated with a source of fluid 21. A conduit 24 includes a valve seat 26 having a seating surface 30. An aperture 28 extends through the valve seat. A flapper 32 selectively closes the aperture 28 to block flow of the fluid through the aperture in a closed position. The valve seat 26, flapper valve 32, and a stop 59 (shown in phantom) could collectively define the check valve 19.

The flapper 32 pivots on a pin 34. Pin 34 allows the flapper 32 to pivot between the closed and open positions. At the open position, the flapper 32 contacts stop 59.

As mentioned above, one type of check valve includes a pair of flapper 32 and 32L. Each have their own fulcrum 33 and 33L pivoting about the pivot pin 34. FIG. 1B illustrates a check valve 17 with a single flapper 32. It should be understood that teachings of this disclosure would apply to dual flapper check valves, such as valve 19 or a single flapper valve such as 17.

As shown in FIG. 1B, the stop 59 may have a generally cylindrical outer periphery 57, at least at the location where the flapper 32 will contact the stop 59. A contact surface 15 on the flapper 32 contacts the stop 59.

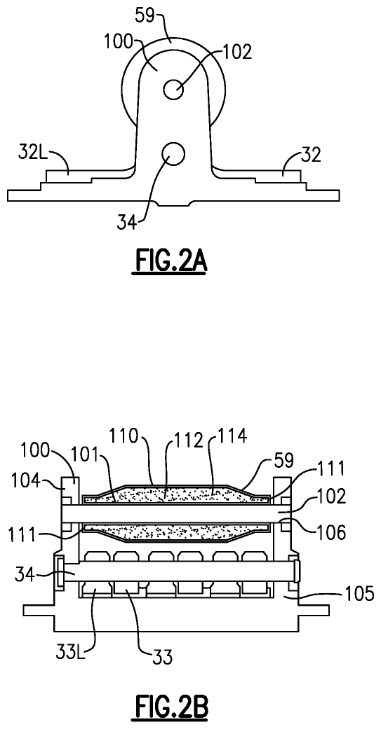

FIG. 2A shows a housing 100 mounting a pin 102 that is part of the stop 59. The flapper valves 32 and 32L are also shown.

As shown in FIG. 2B, the housing 100 actually includes two brackets 104 and 105 which mount the pivot pin 34 for the fulcrums 33 and 33L. The stop 59 is shown mounted about pin 102, and having an internal solid surface 101 spaced from an outer solid surface 110. A hollow 112 is intermediate the solid surfaces 101 and 110 and end surfaces 111. The hollow is filled with an entrapped particulate material 114. In an embodiment, the solid portions 101, 110 and 111 and the particulate material 114 are all metal.

Returning to FIG. 1B, when the flapper 32 strikes the stop 59, in a sense, the solid portion 110 acts as a spring attached to a damper (the particulate material 114). Powder or particle dampers are known, however, they have not been utilized in check valve applications.

The particulate material 114 will dissipate the energy from the contact between the flapper 32 and the stop 59.

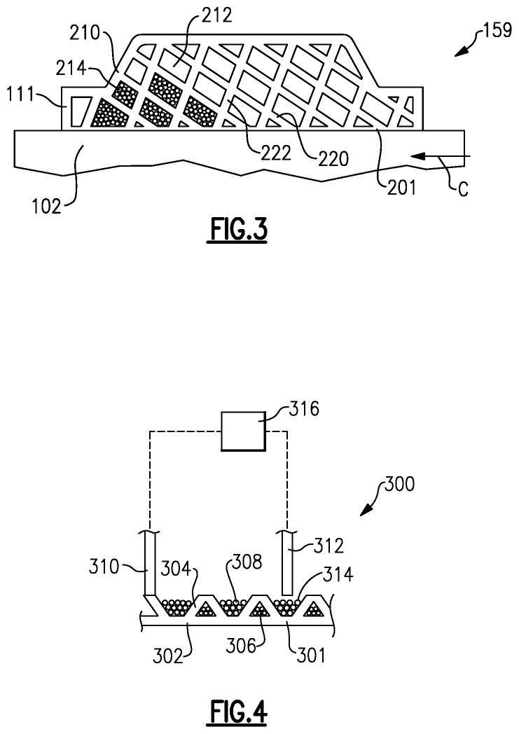

FIG. 3 shows another stop embodiment 159. Here, there is the outer solid surface 210, inner surface 201 and a lattice structure including crossing rails 220 and 222. The crossing rails 220 and 222 extend at opposed angles relative to a central axis C of the stop. The central axis C may be on the center of the pin 102 (see FIG. 2B).

There are hollows 212 between the rails 220 and 222. Those hollows are filled with particulate material 214. While only a few hollows 212 are shown filled with particulate material in the FIG. 3 embodiment, it should be understood that all hollows could be filled.

In addition, it should be understood that the hollows may be effectively enclosed and trap the powder. Such hollows could be said to be generally fluidly sealed relative to each other due to the rails 220 and 222. On the other hand, the hollows may be open relative to each other.

FIG. 4 shows a method of manufacturing 300 for forming a stop such as stops 59 or 159. As shown, an intermediate product 301 includes solid structure 302, rail portions 304, and hollows 306. A machine 310, which may be an additive manufacturing machine, lays down material in layers to form the stop. It should be understood that additive manufacturing techniques are known, however, they have not been utilized to form structures such as that disclosed here.

Another machine 312 is shown depositing the particulate material 314 into what will become another hollow once the manufacturing has progressed to enclose the location of the particulate material 314. The machines 310 and 312 may be different machines, or may be the same machine.

In one example, the additive manufacturing may be selective laser melting. In such a technique, the machines 310 and 312 are the same machine. The material being deposited to form the solid structure 302 is metal particles which are heated as deposited such that they fuse to underlying layers. A control (316), shown schematically, may be controlled to selectively stop the application of heat to the particle when it is time to form the particles 314. Thus, when metal is deposited to form solid structure 302, the metal particles are heated and fused, and when it becomes time to deposit particulate material 314, the metal particles are not heated. To be clear, selective laser melting is an additive process in which layers of powder (particles) are spread successively. Within a layer, a laser locally melts the particles to from the desired solid. Generally, unfused particles are left entrapped to form the particulate material. In this embodiment, the particulate material 314 and the solid structure 302 are formed of a homogeneous material.

In other additive manufacturing embodiments, additive manufacturing extrusion (such as FFF—Fused filament fabrication, FDM—Fused deposition modeling, or BMD Bound metal deposition) may be utilized. In such methods, a filament is melted into a layer through the machine 310. Then, the machine 312 may be a distinct machine which deposits particulate materials.

In another embodiment, photopolymerization (SLA—Stereolithography apparatus, DLP—Direct light processing, CLIP—Continuous liquid interface production) may be utilized. In these embodiments, a resin is deposited. And a machine cures the resin particles to form a solid portion 312. In these embodiments, the particulate may also be deposited by a distinct machine 312.

Binder jetting (BJ) or material jetting (MJ) (3DP-3D printing, polyjet or multijet) may be utilized. In these embodiments, a layer is spread and a binder or additional material is shot into portions of the layer to form the solid portions. Again, some other machine 312 may then be utilized to deposit the particulate material.

Material Jetting dispenses a photopolymer from hundreds of tiny nozzles in a printhead to build a part layer-by-layer. This allows material jetting operations to deposit build material in a rapid, line-wise fashion compared to other point-wise deposition technologies that follow a path to complete the cross-sectional area of a layer. As the droplets are deposited to build a platform they are cured and solidified using UV light. Material jetting processes require support and this is often printed simultaneously during the build from a dissolvable material that is easily removed during post-processing.

Nano particle jetting (NPJ) uses a liquid, which contains metal nanoparticles or support nanoparticles, loaded into the printer as a cartridge and jetted onto the build tray in extremely thin layers of droplets. High temperatures inside the build envelope cause the liquid to evaporate leaving behind metal parts.

Binder Jetting deposits a binding adhesive agent onto thin layers of powder material. The powder materials are either ceramic-based (for example glass or gypsum) or metal (for example stainless steel). The print head moves over the build platform depositing binder droplets, printing each layer in a similar way 2D printers print ink on paper. When a layer is complete, the powder bed moves downwards and a new layer of powder is spread onto the build area. The process repeats until all parts are complete. After printing, the parts are in a green state and require additional post-processing before they are ready to use.

In the embodiments which utilize a distinct machine 312, the particulate can be formed of a distinct material from the material utilized to form the solid portion 302.

The programming of the control 316 is within the skill of a worker in this art. The additive manufacturing technology is well-developed and a worker of ordinary skill would be able to provide an appropriate program to achieve the method as disclosed above or below.

Of course, other manufacturing techniques might be utilized.

While a particular lattice shape is disclosed in FIG. 3, other shapes such as honeycomb or gyroids may be utilized. In addition, a single set of rails extending along similar angles may be utilized rather than the crossing rails of FIG. 3. All of these embodiments would include “rails” as defined in this application. Thus, that is, for purposes of this application, a “rail” does not extend only to the illustrated embodiments. It also extends to other shapes, such as honeycomb, and even to non-linear shapes such as a gyroid.

The lattice structure is formed of rails within the stop to provide additional rigidity to said stop.

A check valve 17/19 under this disclosure could be said to include a valve seat 26 defining an aperture 28 and a seating surface 30. A stop 59/159 is fixed in position relative to the valve seat, and has a solid portion formed as a single homogeneous component. At least one cavity is sealed within the solid portion, and at least partially filled with a particulate material. The solid portion defines a contact surface 15. A flapper 32 is moveable between a closed position, in which the flapper is sealingly engaged with the sealing surface, and an open position, in which a contact surface of the flapper is in contact with the stop.

The particulate material is movable within the at least one cavity to dampen an impact forces generated when the flapper contacts the stop during opening of the check valve. The particulate material is sized and configured to provide damping based on physical characteristics of the check valve, and anticipated impact loads during opening of the check valve. An amount of the particulate material within the at least one cavity is selected to dampen impact loads during opening of the check valve.

A worker of ordinary skill in the art, armed with this disclosure, would be able to select and design the particulate material sizes and configuration, along with the amount of particulate material based upon the aspects as mentioned above.

A method of forming a check valve stop including depositing material layer by layer to form a solid portion of the check valve stop as a single homogeneous component having at least one cavity sealed within the solid portion. The method further includes the step of depositing particulate material within at least one cavity during the layer by layer depositing process.

Although an embodiment of this invention has been disclosed, a worker of ordinary skill in this art would recognize that certain modifications would come within the scope of this disclosure. For that reason, the following claims should be studied to determine the true scope and content of this disclosure.

1. A check valve comprising:
a valve seat defining an aperture and a seating surface;
a stop fixed in position relative to the valve seat and having a solid portion formed as a single homogeneous component, and at least one hollow sealed within the solid portion being at least partially filled with a particulate material, the solid portion defining a contact surface; and
a flapper moveable between a closed position, in which the flapper is sealingly engaged with the sealing surface, and an open position, in which a contact surface of the flapper is in contact with the stop;
wherein said particulate material is the same material as a material forming said single homogeneous component.

2-8. (canceled)

9. A check valve comprising:
a valve seat defining an aperture;
a flapper pivoting about a pivot axis defined by a fulcrum and having a contact surface for contacting a stop in an open position, said stop being formed to include an outer solid surface which will be contacted by said flapper, and at least one hollow, with a particulate material received within said at least one hollow;
wherein said at least one set of rails includes at least two sets of rails extending in opposed directions relative to each other to define said plurality of hollows, with said opposed directions being opposed relative to a central axis of said stop.

10-20. (canceled)
